(19) United States
(12) Patent Application Publication
(10) Pub. No.: US 2024/0219751 A1
(43) Pub. Date: Jul. 4, 2024

(54) Wear glasses with cut-off-sections at bottom nasal corners of the lenses

(71) Applicant: Henoch M.A. Offman, Bet Shemesh (IL)

(72) Inventor: Henoch M.A. Offman, Bet Shemesh (IL)

(21) Appl. No.: 18/610,424

(22) Filed: Mar. 20, 2024

Related U.S. Application Data
(63) Continuation-in-part of application No. 17/969,699, filed on Oct. 20, 2022.

(51) Int. Cl. G02C 7/06

(52) U.S. Cl. CPC G02C 7/06

(57) ABSTRACT

Eyeglasses and sunglasses with a cut-off-left-section in the bottom-nasal-left-corner of the right lens and a cut-off-right-section in the bottom-nasal-right-corner of the left lens. The area of the bottom nasal quadrant of the left lens and of the right lens is less than seventy percent of the area of the bottom temporal quadrant of the lenses. The eyeglasses and the sunglasses enable the user to look through the cut-off-sections while wearing the eyeglasses or the sunglasses. Reading glasses with a left-nasal-corner lens in the bottom-nasal-left-quadrant of the right frame, and a right-nasal-corner lens in the bottom-nasal-right quadrant of the right frame. The area of each lens is less than seventy percent of the area of the bottom nasal quadrant each frame.

### RELATED APPLICATIONS

This application is a continuation in part of U.S. patent application Ser. No. 17/969,699 filed on Oct. 20, 2022.

### FIELD OF THE INVENTION

The invention relates to “window phone lenses” for eyeglass that are eyeglasses lenses with a window cut out of the lens in order to make it possible to look through the window and see better without taking off the eyeglasses.

### BACKGROUND ART

There are nearsightedness people (myopia) that distant objects appear blurry and there are people who use reading glasses. For many people who are wearing eyeglasses, the invention facilitates the use of the phone or reading a note while wearing the eyeglasses (nearsighted). People who need their lenses only to see from far and are able to read text on the phone or notes without any lenses, generally children and adults below the age of frothy. For that category of people who would have like to use their phone, for example, without any lenses in order to see sharper, now they can do that with the “Window Phone Lenses” of the present invention.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1A depicts the right lens (11).

FIG. 1B depicts the left lens (13).

FIG. 2A depicts the right lens divided to four quadrants.

FIG. 2B depicts the left lens divided to four quadrants.

FIG. 3 depicts the nearsighted eyeglasses (10).

FIG. 4 depicts the sunglasses (20).

FIG. 5 depicts the reading glasses (30).

FIG. 6 depicts the nearsighted eyeglasses (10).

FIG. 7 depicts the reading glasses (30).

FIG. 8 depicts the sunglasses (20).

### THE INVENTION

For that category of people, nearsighted, who would have like to use their phone, for example, without any lenses in order to see sharper, now with the “Window Phone Lenses”, there is no need to take off the eyeglasses or to look underneath them while using the phone or reading a note for a second. One can now just look through the “window” part which is a cut out of the lower part of the lenses and see perfectly. Also for nearsighted people who are already wearing lenses with a low “minus” prescription, and have now reached the age of approximately forty, and started to need also a “plus” prescription, that is not higher than the number of their “minus” prescription, in order to see well from close. Such people will now be able to use their phone without being forced to use bifocals or expensive multifocals, and without having to take off their eyeglasses. They can just use the Window Phone Lenses with the window cut out of the lower part of the lenses and enjoy using their eyes without lenses while using their phone for example.

By the one type of fashion of eyeglasses, the lenses are small and narrow, so near sighted people were able to look easily underneath their lenses when using their phone in order to see sharper. But when using large lenses, which is another type of fashion, the near sighted people cannot look below their eyeglasses when using the phone in order to see well. The present invention solves this problem by providing the Window Phone Lenses.

By using the Window Phone Lenses the near sighted people can wear eyeglasses with large lenses when they find them suite to their taste of fashion.

When the phone is ringing, far sighted have to take out their reading glasses from their pocket and put them on quickly before the phone stops ringing. This procedure happens many times a day putting pressure on the person and making it hard for him. Therefore, a lot of people are wearing their reading glasses constantly in order to avoid such situations. However, a new problem arises. Now it is hard for them to see from far. Also, when using regular reading glasses for reading or writing, and while reading or writing someone asks them something, they usually have to take off their glasses in order to see the person, and these interruptions feel annoying. The present invention solves this problem too.

By using the Window Phone Lenses people will no longer need to use all day long their reading glasses, and will not have to buy expensive multifocals eyeglasses or bifocal, the user will be able to see clearly from a far by looking through the window part of his reading glasses, and will be able to see clearly from up close by using the lenses part of his reading glasses.

The advantageous of the Window Phone Lenses for near sighted children is slowing down Myopia progression, as explained here below:

Today, the most widespread system in the world for Myopia control for children is to give a child bifocal lenses. Each lens is divided into two parts: The top part is to see from far. The bottom part is to see from close. The prescription number on the bottom of the lens is lower than the prescription number on the top of the lens. This is in order to facilitate reading from close which does not require as high a prescription number as to see from far.

This type of eyeglass lens reduces strain on the eyes during reading. Therefore there is less tension on the retina and there is a good chance to control myopia. This method works for children from age six until the age when they stop growing. However, most children who need glasses to see from far do not need glasses at all to see from close. Indeed, when a child is given glasses with which to read when he does not need it, even if the glasses have a low prescription, it makes it harder to read and to see from close.

The WP Lens of the present invention provides an ideal solution! There is only a prescription to see from far and there is no prescription at all to read from close! This is due to the window which is cut out at the bottom of the lens.

This method works for children who do not need glasses for reading from close up and who have a low prescription to see from far.

This method also works for children who need no prescription in order to read from close up, yet they need a high prescription in order to see from far. These children can use the WP Lenses as usual when using the telephone and when reading a newspaper by bringing the telephone or the newspaper closer to their eyes according to the need. For these children, when reading books and when writing on papers which are on a desk, it is necessary for them to bring their eyes closer to the reading and writing material according to the need.

The WP Lenses can also raise a child's self-confidence and mood by enabling the child to read naturally from close up.

Another advantage of the WP Lenses is that the windows in these lenses do not become fogged up! Therefore, when one comes inside from the cold outdoors, there is no need to wipe the lenses in order to be able to read or write from close up or to use the telephone.

When one would like to use a cellular phone right after being caught outdoors in a sudden rainstorm, one must first wipe off the drops of rain from bifocal lenses in order to see clearly from close up. The WP Lenses conveniently do not have to be wiped off because the window remains an open space which does not retain raindrops. Therefore it is easier to make and receive phone calls right away. Another advantage is that the WP Lenses are cheaper than bifocal and progressive lenses.

The advantageous of the Window Phone Lenses for far sighted people are: The users will be able to wear them all the time without having to take them off when looking afar. Users will use large frames when this will be the fashion. They are cheaper than multifocals.

Many users, mainly over forty, are unable to get used to bifocal and to multifocals and the Window Phone Lenses of the present invention give them the best solution. In addition to that, when it's raining the lenses get wet and it is hard to see clearly, so looking through the window part of the eyeglasses enables the user to see much better than having to look through the wet lenses. In addition, when entering a warm place in a cold day the lenses are blurred by humidity and the user is forced to take them off immediately, and by using the Window Phone Lenses of the present invention the user can simply look through the window. The invention can be applied also on sunglasses, simply normal and regular sunglasses, as opposed to sunglasses whose lenses are also vision lenses for those who have myopia. Sometimes the sunglasses do not allow a quick reading of a note or a text on the mobile phone, because they darken the vision, and using the invention solves this problem. Also, for example while driving, the driver must wear sunglasses to protect his eyes from the glare of the sun, although occasionally he must look at the dashboard, and the sunglasses do not allow clear vision, in which case the invention offers a good solution.

It must be noted that at first reading it can be considered that the glasses with the lenses that are the subject of the present invention can be unattractive (despite their effectiveness in the cases described above), but it is the nature of fashion that it can surprise anyone. For example, in the distant past no one would have thought that ripped jeans would be fashionable; that people would buy new jeans in advance when they were torn, as well as new jeans with a used look. Likewise, it seems that the solution proposed above can be a unique and chic fashion model in itself.

Also, it is possible for a person to hold a pair of glasses according to the invention for special cases, such as professionals when driving for a long time, or during work or missions that requires a frequent transition from looking far to looking nearby, such as a bank clerk who interviews a customer and looks at the customer while he is talking to him and from time to time must type on the computer or on a paper form details that the customer gives him.

The first embodiment of the present invention refers to nearsighted eyeglasses (10). The general structure of the nearsighted eyeglasses (10) of the present invention is similar to standard and known nearsighted eyeglasses, and the difference is reflected in the fact that the lenses of the eyeglasses of the present invention include the cut-off-left-section and the cut-off-right-section in the bottom-nasal-corners of the right and left lenses.

The “boxing system”: The lenses and eyewear industry adopted the boxing system to provide a standard frames and lenses measurements. The boxing system is based upon the idea of drawing an imaginary box around a lens shape with the sides of the box tangent to the outer most edges of the shape. The system uses the sides of the boxes as reference points for the standard system of measurements. In this spirts and concept we divided each lens to four quadrants, by adding imaginary box (inscribed rectangle) around the lens and dividing this inscribed rectangular box (500R) (500L) according to its geometric center (501), the horizontal axis (502) and the vertical axis (503) to four quarters: an upper temporal quarter (504), an upper nasal quarter (504), a bottom nasal quarter (506) and a bottom temporal quarter (507).

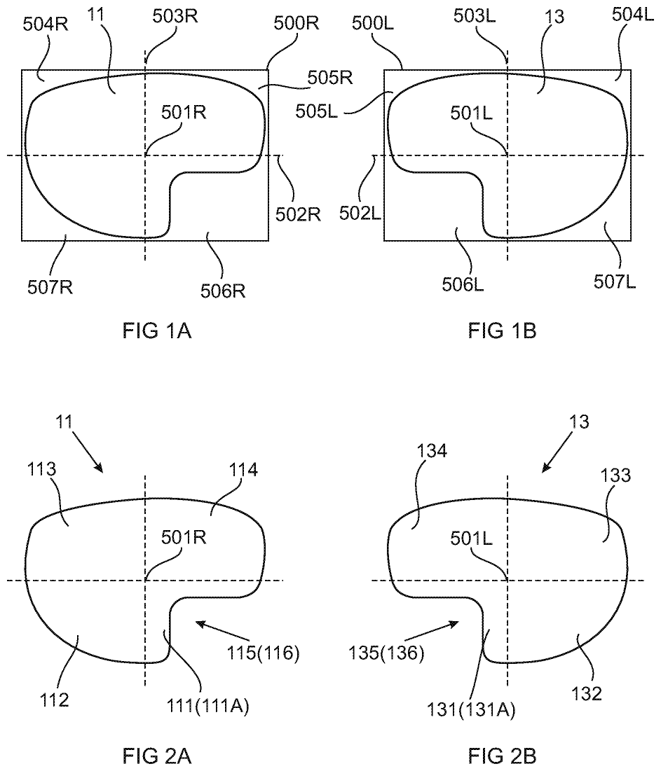

FIG. 1A depicts the right lens (11) with the right inscribed rectangular box (500R), and FIG. 2A depicts the right lens of FIG. 1A that is divided to four quadrants: A bottom nasal quadrant (111), bottom temporal quadrant (112), an upper temporal quadrant (113), and an upper nasal quadrant (114). FIG. 1B depicts the left lens (13) with the left inscribed rectangular box (500L), and FIG. 2B depicts the left lens of FIG. 1B that is divided to four quadrants: A bottom nasal quadrant (131), bottom temporal quadrant (132), an upper temporal quadrant (133), and an upper nasal quadrant (134).

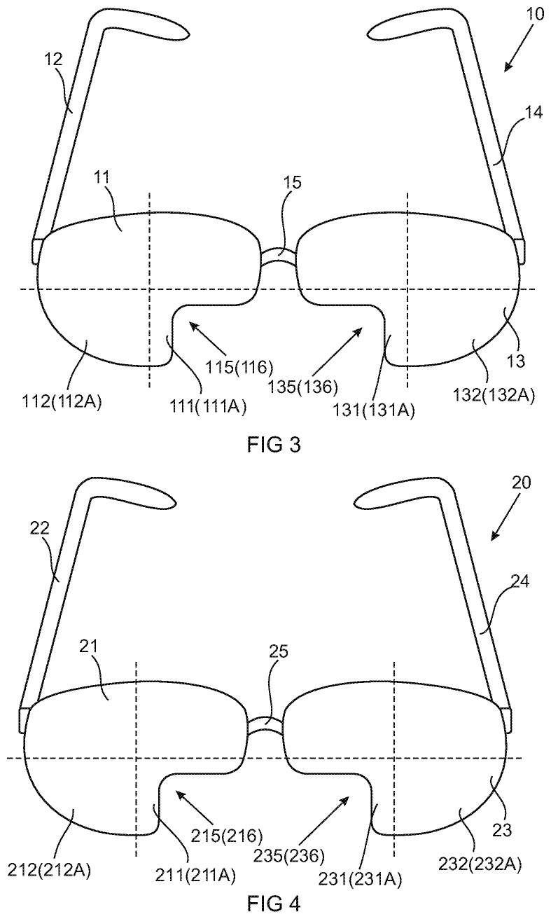

The nearsighted eyeglasses (10) of the first embodiment of the present invention are depicted in FIG. 3 and comprise:
A. A right lens (11) with a cut-off-left-section (115) in the bottom-nasal-left-corner (116) of the right lens, such that the area (111A) of the bottom nasal quadrant (111) of the right lens is less than seventy percent of the area (112A) of the bottom temporal quadrant (112) of the right lens.
B. A right temple (12) that is connected to the right lens (11), possible by a hinge and a screw as customary and known in the art.
C. a left lens (13) with a cut-off-right-section (135) in the bottom-nasal-right-corner (136) of the left lens, such that the area (131A) of the bottom nasal quadrant (131) of the left lens is less than seventy percent of the area (132A) of the bottom temporal quadrant (132) of the left lens.
D. A left temple (14) that is connected to the left lens, and possible by a hinge and a screw as customary and known in the art.
E. A nose bridge (15) that is connected to the right lens and to the left lens, possibly as known in the art.

The nearsighted eyeglasses (10) are designed in the structure described above and by that these eyeglasses enable a nearsighted user while wearing the eyeglasses to look through the cut-off-left-section and the cut-off-right-section (means to see objects not through lenses) for reading, writing or watching a smartphone. The user does not need to remove the eyeglasses when switching from a far view (in which case he must see through the optical lenses) to a close view (in which case it is better for him to see not through lenses, that is, a direct view without nothing between the eyes and the object).

The term “cut-off-section” (right or left) in this disclosure regarding the eyeglasses and in the claims means a hole (empty of lenses) cut out in the corner or inside the lenses.

It is clear from the explanations above and from the drawings that the bottom temporal quarters is on the same horizontal plane as the bottom nasal quarters, and therefore the bottom nasal quadrants of the right lens (111) and of the left lens (131) are also on the same horizontal plane as the bottom temporal quadrants of the right lens (112) and of the left lens (132), and it is clear that the area of the bottom nasal quadrant is smaller than the area of the bottom temporal quadrant, and experiments shows that it preferably be smaller than seventy percent, that is, about thirty percent of the bottom nasal quadrant was cut in its corner closest to the nose to create the cut-off-section.

The sunglasses (20) of the second embodiment of the present invention are described in FIG. 4 and comprise:
A. A right lens (21) with a cut-off-left-section (215) in the bottom-nasal-left-corner (216) of the right lens, such that the area (211A) of the bottom nasal quadrant (211) of the right lens is less than seventy percent of the area (212A) of the bottom temporal quadrant (212) of the right lens.
B. A right temple (22) that is connected to the right lens (21), possible by a hinge and a screw as customary and known in the art.
C. a left lens (23) with a cut-off-right-section (235) in the bottom-nasal-right-corner (236) of the left lens, such that the area (231A) of the bottom nasal quadrant (231) of the left lens is less than seventy percent of the area (232A) of the bottom temporal quadrant (232) of the left lens.
D. A left temple (24) that is connected to the left lens, and possible by a hinge and a screw as customary and known in the art.
E. A nose bridge (25) that is connected to the right lens and to the left lens, possibly as known in the art.

The sunglasses (20) are designed in the structure described above and by that these sunglasses enable the user while wearing the sunglasses to look through the cut-off-left-section and the cut-off-right-section (means to see objects not through the dark sun lenses) for reading, writing or watching a smartphone in a room when is too dark to see well through sunglasses lenses. The user does not need to remove the sunglasses when switching from a far view to outdoor bright sunny day (in which case he prefer to see through the dark lenses) to a close view in a shadow (in which case it is better for him to see not through these dark lenses, that is, a direct view without dark lenses between the eyes and the object).

The term “cut-off-section” (right or left) in this disclosure regarding the sunglasses and in the claims means a hole (empty of lenses).

It is clear from the explanations above and from the drawings that the bottom temporal quarters is on the same horizontal plane as the bottom nasal quarters, and therefore the bottom nasal quadrants of the right lens (211) and of the left lens (231) are also on the same horizontal plane as the bottom temporal quadrants of the right lens (212) and of the left lens (232), and it is clear that the area of the bottom nasal quadrant is smaller than the area of the bottom temporal quadrant, and experiments shows that it preferably be smaller than seventy percent, that is, about thirty percent of the bottom nasal quadrant was cut in its corner closest to the nose to create the cut-off-section.

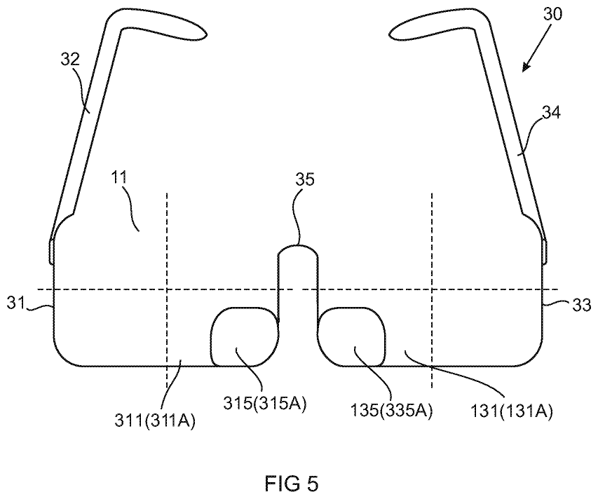

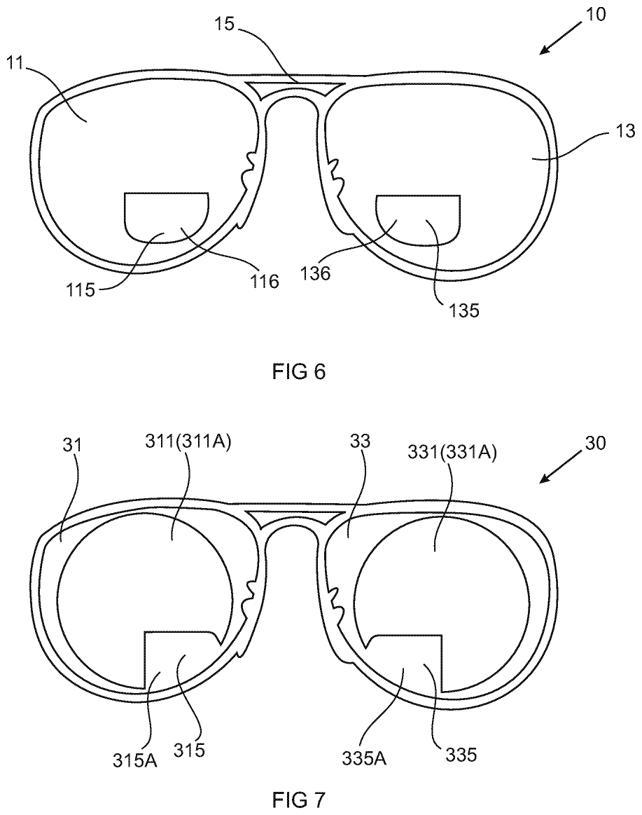

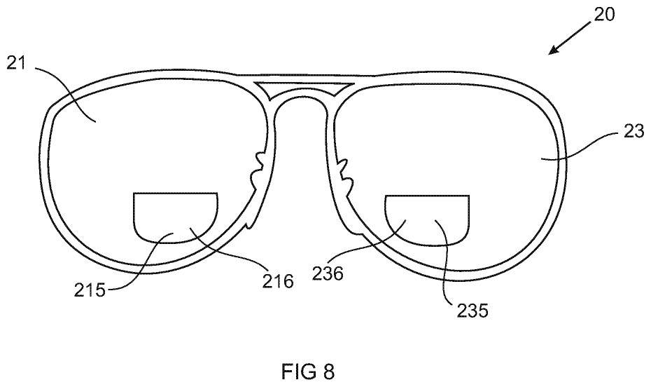

The reading glasses (30) of the third embodiment of the present invention are depicted in FIG. 5 and comprise:
A. A right frame (31) with a left-nasal-corner lens (315) in the bottom-nasal-left-quadrant (311) of the right frame, wherein the area (315A) of the left-nasal-corner lens is less than seventy percent of the area (311A) of the bottom nasal quadrant (311) of the right frame.
B. A right temple (32) that is connected to the right frame (31), possible by a hinge and a screw as customary and known in the art.
C. A left frame (33) with a right-nasal-corner lens (335) in the bottom-nasal-right quadrant (331) of the left frame, wherein the area (335A) of the right-nasal-corner lens is less than seventy percent of the area (331A) of the bottom nasal quadrant (331) of the left frame.
D. A left temple (34) that is connected to the left frame, and possible by a hinge and a screw as customary and known in the art.
E. A nose bridge (35) that is connected to the right frame and to the left frame, possibly as known in the art.

The reading glasses (30) are designed in the structure described above and by that these glasses enable the user to look through the frames (empty frames) while wearing the glasses and to look through the corner optical lenses (315 and (335) for reading, writing or watching a smartphone. The area (315A) of the lens (315) in the right frame (31) is less than seventy percent than the area (311A) of the bottom nasal quadrant (311) of the right frame, and the area (335A) of the lens (335) in the left frame (33) is less than seventy percent than the area (331A) of the bottom nasal quadrant (331) of the left frame.

The user does not need to remove the reading glasses when switching from a close view (in which case he must see through the optical lenses for reading etc.) to a far view (in which case it is better for him to see not through lenses, that is, a direct view without lenses between the eyes and the far objects). The frame of the reading glasses is completely empty of lenses except for a very small optical lens for reading that is put only in the bottom nasal corners for the right and left eyes.

The eyeglasses (10) of the present invention have substantially a full right lens with a cut-off-section in a lower-left-nasal corner of the right lens (in the lower-left corner of the lens). The lenses of the eyeglasses (10) are substantially complete with the cut-off-nasal corners in the lower corners near the nose (nasal). Also, the lenses of the present invention provide narrow and focused angle of vision through the lower-cuts in the corners near the user's nose and still enables the user to see to the sides in the lower part of the field of vision through the lenses (which are full except for the cut-off corner sections).

The lenses of the eyeglasses and the sunglasses have cut-off sections in the lower-side corners (nasal corners) near the nose and the frames of the reading glasses are empty and the optic lenses are only in that lower-side corners parts of the frames.

The present invention enables vision through the lenses to the field of vision upwards, downwards and towards the sides (which is relevant to the eyeglasses and the sunglasses), except through the lower-side corners near the user's nose, which enable vision outside of the lens through a narrow area only, and that is so on the reversal way regarding the reading glasses.

What is claimed is:

1. A nearsighted eyeglasses that comprise:
(a) a right lens that has a cut-off-left-section in a bottom-nasal-left-corner of the right lens, such that an area of a bottom nasal quadrant of the right lens is less than seventy percent of an area of a bottom temporal quadrant of the right lens,
(b) a right temple that is connected to the right lens,
(c) a left lens that has a cut-off-right-section in a bottom-nasal-right-corner of the left lens, such that an area of a bottom nasal quadrant of the left lens is less than seventy percent of an area of a bottom temporal quadrant of the left lens,
(d) a left temple that is connected to the left lens, and
(e) a nose bridge that is connected to the right lens and to the left lens;
wherein the nearsighted eyeglasses are designed to enable a nearsighted user to look through the cut-off-left-section and the cut-off-right-section while wearing the nearsighted eyeglasses.

2. Sunglasses that comprise:
(a) a right lens with a cut-off-left-section in a bottom-nasal-left-corner (216) of the right lens, such that an area of a bottom nasal quadrant of the right lens is less than seventy percent of an area of a bottom temporal quadrant of the right lens,
(b) a right temple that is connected to the right lens,
(c) a left lens with a cut-off-right-section in a bottom-nasal-right-corner of the left lens, such that an area of a bottom nasal quadrant of the left lens is less than seventy percent of an area of a bottom temporal quadrant of the left lens,
(d) a left temple that is connected to the left lens, and
(e) a nose bridge that is connected to the right lens and to the left lens;
wherein the sunglasses are designed to enable a user to look through the cut-off-left-section and the cut-off-right-section while wearing the sunglasses.

3. Reading glasses that comprise:
(a) a right frame with a left-nasal-corner lens in a bottom-nasal-left-quadrant of the right frame, wherein an area of the left-nasal-corner lens is less than seventy percent of an area of the bottom nasal quadrant of the right frame,
(b) a right temple that is connected to the right frame,
(c) a left frame with a right-nasal-corner lens in a bottom-nasal-right quadrant of the left frame, wherein an area of the right-nasal-corner lens is less than seventy percent of an area of the bottom nasal quadrant of the left frame,
(d) a left temple that is connected to the left frame, and
(e) a nose bridge that is connected to the right frame and to the left frame.
